(19) United States
(12) Patent Application Publication
(10) Pub. No.: US 2011/0268989 A1
(43) Pub. Date: Nov. 3, 2011

(54) COBALT-NICKEL SUPERALLOYS, AND RELATED ARTICLES

(75) Inventors: Akane Suzuki, Clifton Park, NY (US); Martin Matthew Morra, Glenville, NY (US); Michael Larsen, Clifton Park, NY (US)

(73) Assignee: GENERAL ELECTRIC COMPANY, Schenectady, NY (US)

(21) Appl. No.: 12/770,156

(22) Filed: Apr. 29, 2010

(51) Int. Cl. B32B 15/01; C22C 30/00

(52) U.S. Cl. 428/668; 420/588; 428/615

(57) ABSTRACT

A cobalt-nickel alloy composition is disclosed comprising, by weight about 30% to about 50% cobalt, about 20% to about 40% nickel, at least about 10% chromium, aluminum; and at least one refractory metal. Moreover, the alloy composition comprises an L1₂-structured γ′ phase having the formula (Co, Ni)₃(Al,Z), wherein Z is at least one refractory metal. Various components made from, or cladded with, the cobalt-nickel alloy compositions are also described.

### BACKGROUND

This invention generally relates to metallic alloy compositions. More specifically, the invention relates to cobalt-nickel alloys useful in high temperature structural applications wherein good high temperature creep strength and environmental resistance, especially sulfidation resistance, are required, and related articles.

Superalloys are often the materials of choice for components intended for high-temperature environments. (The term “superalloy” is usually intended to embrace complex nickel-, iron- or cobalt-based alloys for high temperature applications which include one or more other elements such as aluminum (Al) and chromium (Cr)). As an example, many hot gas path components of aircraft engines, industrial gas turbines and gasification systems are often formed of nickel-based or cobalt-based superalloys because they need to maintain their mechanical and/or environmental integrity at elevated temperatures. The alloys can be formed by a variety of processes, such as conventional casting and unidirectional casting techniques. Some of the conventional cast materials often go through thermo-mechanical processing, such as rolling, forging and extrusion. A number of heat treatment steps usually follow casting, such as solutioning, aging, and precipitation-strengthening. The alloys may also be provided with an environmental protection coating.

Many nickel-base superalloys use precipitation strengthening by providing the alloy with an “L1₂”-structured γ′ phase. The addition of various elements, such as Al, Ta, Ti and Nb to the nickel (Ni) matrix results in the formation of the γ′-Ni₃(Al, M) phase with L1₂ structure, where M represents at least one metallic element. As those in the art understand, the presence of the L1₂ phase provides greater strength to the alloy at very high use temperatures. In fact, in many instances, the L1₂ phase exhibits an inverse temperature dependence, in which strength increases with rising temperature.

The cobalt-based alloys are also of special interest for certain end uses. As an example, these alloys sometimes exhibit higher melting temperatures than their nickel counterparts. Depending on specific formulations, the cobalt (Co) alloys can potentially provide enhanced oxidation and corrosion resistance in a variety of high-temperature environments which contain corrosive gases, such as hydrogen sulfide (H₂S). However, the application of cobalt-based alloys in high temperature structural components can be limited due to their generally inferior high temperature strength as compared to nickel-base superalloys. Most of the conventional cobalt-base alloys use precipitation of carbides and additions of solid-solution strengthening elements, which are not as effective as precipitation of an L1₂ γ′ phase, in achieving high temperature strength.

Up until recently, cobalt-based alloys which included the desirable L1₂ phase appeared to be unavailable. However, in U.S. Patent Publication 2008/0185078, Ishida et al describe cobalt-based alloys with high heat resistance and strength, and which contain a precipitated L1₂ phase. The L1₂ γ′ phase in this instance is an intermetallic compound of the formula CO₃(Al,W). While the alloy compositions in Ishida may contain a number of other elements, most of the compositions appear to be based on relatively large amounts of cobalt, aluminum, and tungsten.

Metallurgists understand that nickel and cobalt alloys used in demanding applications often require a very careful balance of properties. Just a few of these properties are mentioned here: strength (at high and medium temperatures), ductility, oxidation resistance, corrosion resistance and wear resistance. Other properties and characteristics include “castability”, hot workability, density and cost. In highly demanding service environments, achieving a necessary balance between all of these properties represents an ever-increasing challenge to the alloy formulator.

In nickel-base and cobalt-base superalloys, oxidation and corrosion resistance strongly depend on Al and Cr content in the alloy. More specifically, the presence of Al is thought to form a protective Al₂O₃ scale on the surface of the alloy at elevated temperatures. Alumina is a slow-growing oxide compared with chromium, and formation of alumina is preferred in some oxidation environments. Alumina is also known to be resistant to sulfidation under corrosive environments containing H₂S. The presence of Cr is believed to be beneficial for the formation of the Al₂O₃ scale, and at temperatures below 900° C., it may also form a stable Cr₂O₃ scale. Generally, a higher Cr content, at least about 12 wt %, is believed to be required to achieve the environmental resistance required in some applications.

Different from many conventional cobalt base superalloys that do not contain Al, a Co—Al—W based alloy system may have a capability to form protective alumina scale due to the presence of Al. However, in Co—Al—W based alloys where the γ′-CO₃(Al,W) phase precipitates, additions of Cr tend to reduce phase stability of the γ′-CO₃(Al,W) phase. In Co—Al—W based alloys containing Cr, the γ′ solvus temperature (where γ′ phase dissolves into the γ-Co matrix phase) is lower than Cr-free alloys. It is generally desirable to keep the γ′ solvus temperature as high as possible, since the high temperature strength of this type of alloy strongly depends on the volume fraction of the γ′ phase at the target temperatures. Therefore, it can be important to balance Cr content and stability of γ′ phase in order to achieve both environmental resistance and high temperature strength.

With these considerations in mind, new superalloy compositions would be welcome in the art. The alloys should exhibit a desirable combination of the properties noted above, such as environmental resistance, high-temperature strength and enhanced creep resistance as compared to conventional cobalt-based alloys.

### BRIEF DESCRIPTION OF THE INVENTION

A cobalt-nickel alloy composition is disclosed herein, comprising, by weight:
about 30% to about 50% cobalt;
about 20% to about 40% nickel;
at least about 10% chromium;
aluminum; and
at least one refractory metal.
   Moreover, the alloy composition comprises L1₂-structured (gamma prime) phase precipitates having the formula (Co, Ni)₃(Al,Z), wherein Z is at least one refractory metal, and a Co—Ni γ matrix phase.

Articles prepared, partly or entirely, from such compositions, represent another embodiment of the invention. Examples of such articles include structural gasification components that require high temperature strength as well as environmental resistance, especially sulfidation resistance, such as gasification nozzles, shelves and cooling systems.

### BRIEF DESCRIPTION OF THE DRAWINGS

FIGS. 1A and 1B are transmission electron micrographs showing gamma prime precipitates formed after aging at 900° C. for 100 hours for two embodiments of the alloy compositions; and

FIGS. 2A and 2B are diagrams showing the gamma-prime solvus temperature of various alloy samples, as a function of aluminum and tantalum content.

### DETAILED DESCRIPTION OF THE INVENTION

The compositional ranges disclosed herein are inclusive and combinable (e.g., ranges of “up to about 25 wt %”, or, more specifically, “about 5 wt % to about 20 wt %”, are inclusive of the endpoints and all intermediate values of the ranges). Weight levels are provided on the basis of the weight of the entire composition, unless otherwise specified; and ratios are also provided on a weight basis. Moreover, the term “combination” is inclusive of blends, mixtures, alloys, reaction products, and the like. Furthermore, the terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The modifier “about” used in connection with a quantity is inclusive of the stated value, and has the meaning dictated by context, (e.g., includes the degree of error associated with measurement of the particular quantity). The suffix “(s)” as used herein is intended to include both the singular and the plural of the term that it modifies, thereby including one or more of that term (e.g., “the refractory element(s)” may include one or more refractory elements). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described inventive features may be combined in any suitable manner in the various embodiments.

The alloy materials described herein may include, but are not limited to, materials provided as a wire, bar, rod, plate, or sheet, materials provided with an equiaxed microstructure or single-crystal structure, and materials provided with a directionally solidified microstructure. Material properties, as discussed herein, are determined under standard industrial tests at the specified conditions, unless otherwise specified. The material compositions set forth herein are provided in approximate weight percent, with weight determined on the basis of the total weight of the alloy, unless otherwise indicated.

The alloy composition of the present invention includes both cobalt and nickel. After some of the various processing steps described below, cobalt, nickel, and several other elements usually form a face-centered cubic (FCC) matrix phase in the alloy. Such a phase is typically associated with superalloys and is known in the art as the “gamma” (γ) phase. The alloys can thus be described as having a a Co—Ni γ matrix phase.

The amount of cobalt in the alloy is in the range of about 30% by weight to about 50% by weight, and in some specific embodiments, about 32% by weight to about 48% by weight. In some embodiments which are especially preferred for specific end uses, the level of cobalt is about 38% by weight to about 46% by weight.

Amounts of more than 20% by weight of nickel are effective in stabilizing the gamma prime (γ′) phase. The amount of nickel in the alloy may thus be in the range of about 20% by weight to about 40% by weight, in some embodiments, of about 20% by weight to about 35% by weight, and in some specific embodiments, of about 20% by weight to about 25% by weight.

As noted previously, the alloy composition of this invention further includes chromium. Chromium is an important constituent for environmental resistance, such as oxidation and corrosion resistance. However, in excessive amounts, chromium can tend to destabilize the γ′-(Co,Ni)₃(Al,W) phase. So, for example, in some embodiments, the alloy composition comprises at least about 10% by weight chromium. In some embodiments, the amount of chromium in the alloy may be in the range of from about 10% by weight to 18% by weight, or from about 12% by weight to about 18% by weight, or in some specific embodiments from about 14% by weight to about 18% by weight.

Aluminum is another important constituent for the alloys described herein. Like chromium, aluminium also provides environmental resistance to the alloy by forming alumina scale. Moreover, for the presently-described alloys, aluminum forms important intermetallic compounds with the base metals, i.e., forming the (Co,Ni)₃(Al, Z) gamma prime (γ′) phase. As mentioned above, this phase is generally known as the L1₂ phase, and functions as a very important high-temperature strengthener. As further described below, “Z” is meant to represent selected refractory metals. (The tungsten-containing phase, i.e., (Co,Ni)₃(Al,W), is often preferred in many embodiments).

Additions of Al to Co—Ni—Cr—W based alloys results in formation of γ′ (Co,Ni)₃(Al,W) phase. However, excess additions of Al can result in the preferential formation of a CoAl phase, undesirable in some applications, over the γ′ phase. In some specific embodiments, the amount of aluminum present is at least about 2% by weight, and more typically, at least about 3% by weight. The upper limit of aluminum is usually about 5%.

As mentioned above, the alloy composition includes at least one refractory metal. In general, the refractory metals improve the high-temperature hardness and high-temperature strength of the alloys. Moreover, tungsten, in particular, can participate in the formation of the L1₂ phase. Other refractory metals include molybdenum, tantalum, niobium, vanadium, and rhenium, and any of these may also be used as alloying elements. Various combinations of these metals may also be present in the alloy. In general, the refractory metals are usually present at a level (total) of at least about 1% by weight, and more often, at least about 10% by weight, based on the weight of the entire composition. Total refractory element content is usually 30% or less by weight. In some preferred embodiments, the total amount of refractory metal is usually in the range of about 10% by weight to about 20% by weight.

In some specific embodiments, tungsten and tantalum are the preferred refractory metals. Moreover, in some cases, it is preferred that at least about 50% of the total refractory metal content (by weight) comprises tungsten. (Tungsten is sometimes especially useful in the formation of the gamma prime phase, which provides strength to the alloy). A useful range for tungsten is often about 1% by weight to about 20% by weight, and in some specific embodiments, about 10% by weight to about 16% by weight, or about 11% by weight to about 15% by weight. The level of tantalum, if present, is usually in the range up to about 4% by weight, and in some cases, up to about 3% by weight.

The alloy compositions of this invention can further comprise a number of other elements which impart properties suitable for certain end use applications. Non-limiting examples of such elements are carbon, silicon, boron, titanium, manganese, iron, hafnium and zirconium. The appropriate amount of each of these elements will depend on a variety of end use requirements.

As an example, boron, at levels up to its solubility limit, can be useful for improving high-temperature hardness and wear resistance, as well as strength. Carbon is sometimes useful, at selected levels, for combination with various other elements, such as chromium, tungsten, molybdenum, titanium, hafnium, niobium, and the like, to form carbides. The carbides can also improve the hardness of the alloys under room temperature and high temperature conditions. Moreover, in selected amounts, silicon can be useful for improving the casting and welding characteristics of the alloy, as well as molten metal fluidity, and environmental resistance.

Titanium, hafnium and zirconium, at selected levels, are often effective for stabilization of the gamma prime phase and the improvement of high-temperature strength. Zirconium and hafnium can also be useful in conjunction with boron, to strengthen grain boundaries. Moreover, manganese can be useful for improving weldability characteristics.

Non-limiting, exemplary ranges can be provided for these elements (when present), based on total weight % in the composition:

C: About 0.001 wt % to about 0.5 wt %;

Si: About 0.01 wt % to about 0.5 wt %;

B: About 0.001 wt % to about 0.2 wt %;

Ti: About 0.01 wt % to about 1 wt %;

Mn: About 0.01 wt % to about 5 wt %;

Fe: About 0.01 wt % to about 5 wt %;

Zr: About 0.01 wt % to about 1 wt %;

Hf: About 0.01 wt % to about 2 wt %.

Those skilled in the art will appreciate that selections for particular levels of the alloy constituents described above are influenced by a number of factors. Thus, within the teachings of this disclosure, alloy formulators would usually consider the tradeoff between strength and ductility, as well as environmental resistance. Other factors also play a part in this alloy “balance”, e.g., economic factors (costs of raw materials), as well as material weights (density).

Those skilled in the art understand that minor amounts of other elements at impurity levels are inevitably present, e.g., in commercially-supplied alloys, or by way of processing techniques. Those impurity-level additions may also be considered as part of this invention, as long as they do not detract from the properties of the compositions described herein.

A specific alloy composition for some embodiments comprises the following constituents:

Co: About 30 wt % to about 50 wt %;

Ni: About 20 wt % to about 40 wt %;

Cr: About 10 wt % to about 18 wt %;

Al: About 2 wt % to about 5 wt %;

W: About 10 wt % to about 16 wt %; and

Ta: Up to about 4 wt %.

In other embodiments, the alloy composition comprises the following constituents:

Co: About 32 wt % to about 48 wt %;

Ni: About 20 wt % to about 35 wt %;

Cr: About 12 wt % to about 18 wt %;

Al: About 3 wt % to about 5 wt %;

W: About 10 wt % to about 16 wt %; and

Ta: Up to about 4 wt %.

In other embodiments, the alloy composition comprises the following constituents:

Co: About 32 wt % to about 48 wt %;

Ni: About 20 wt % to about 35 wt %;

Cr: About 14 wt % to about 18 wt %;

Al: About 3 wt % to about 5 wt %;

W: About 11 wt % to about 15 wt %; and

Ta: Up to about 3 wt %.

In yet other embodiments, the alloy composition comprises the following constituents:

Co: About 38 wt % to about 46 wt %;

Ni: About 20 wt % to about 25 wt %;

Cr: About 14 wt % to about 18 wt %;

Al: About 3 wt % to about 5 wt %;

W: About 11 wt % to about 15 wt %; and

Ta: Up to about 3 wt %.

The alloy compositions of this invention can be prepared by way of any of the various traditional methods of metal production and forming. Traditional casting, powder metallurgical processing, directional solidification, and single-crystal solidification are non-limiting examples of methods suitable for forming ingots of these alloys. Thermal and thermo-mechanical processing techniques common in the art for the formation of other alloys are suitable for use in manufacturing and strengthening the alloys of the present invention. Various details regarding processing techniques and alloy heat treatments are available from many sources. One example includes U.S. Pat. No. 6,623,692 (Jackson et al), incorporated herein by reference. Moreover, various forging and machining techniques could be used to shape and cut articles formed from the alloy composition.

In some embodiments, the alloy compositions can be formed into a pre-determined shape, and then subjected to a solution treatment, followed by an aging treatment. Solution treatment is conducted at temperatures above γ′ solvus temperature and below the solidus temperature of the alloy. In the aging treatment, the alloy is typically heated at a temperature below the γ′ solvus in order to precipitate the desired phase, e.g., (Co,Ni)₃(Al,Z) in Co—Ni γ matrix phase, where Z is at least one refractory metal. As described above, (Co,Ni)₃(Al, Z) is the “L1₂”-structured phase for the alloy, which provides some of its important attributes. (Depending on the overall formulation, the “L1₂”-structured phase may contain some of the other elements discussed previously, such as chromium).

The cobalt-nickel alloys of this invention can be formed into many shapes and articles, e.g., plates, bars, wire, rods, sheets, and the like. As alluded to previously, the attributes of these alloys make them especially suitable for high temperature articles and articles whose lives may tend to be limited by high temperature creep strength when formed from conventional cobalt based alloys. Examples include various gasification components that require both environmental resistance and high temperature strength. Specific, non-limiting examples of the components include gasification nozzles, shelves, cooling system components and the like.

In another aspect of this invention, the cobalt-nickel superalloys could be used to protect other articles or alloy structures. As an example, a layer of the alloy composition can be attached or otherwise formed on another alloy structure or part which requires properties characteristic of this alloy composition, e.g., environmental resistance and high temperature strength. (The underlying substrate could be formed of a variety of metals and metal alloys, e.g., iron, steel alloys, or other nickel- or cobalt-alloys). The overall product could be considered a composite structure, or an “alloy cladding” over a base metal or base metal core. Bonding of the cladding layer to the underlying substrate could be carried out by conventional methods, such as diffusion bonding, hot isostatic pressing, or brazing. Moreover, those skilled in the art would be able to select the most appropriate thickness of the cladding layer, for a given end use, based in part on the teachings herein.

### EXAMPLES

The examples presented below are intended to be merely illustrative, and should not be construed to be any sort of limitation on the scope of the claimed invention.

Alloy compositions were selected based on a conventional cobalt-base alloy Haynes 188 that mainly consists of Co-22% Cr-22% Ni-14% W-3% Fe-0.1% C. Additions of 2-5 wt % of Al were made in Co-22% Cr-22% Ni-14% W and Co-16% Cr-22% Ni-14% W. In addition, 1-2 wt % of Ta additions were made in Co-22% Cr-22% Ni-14% W-4% Al and Co-16% Cr-22% Ni-14% W-4% Al. An alloy with high Ni content was made with 4% Al addition.

TABLE 1
Composition

| Sample | Co | Cr | Ni | W | Al | Ta | Fe | C |
|---|---|---|---|---|---|---|---|---|
| Haynes188 | 38.9 | 22 | 22 | 14 | 0 | 0 | 3 | 0.1 |
| Comparative | | | | | | | | |
| Base | 42 | 22 | 22 | 14 | 0 | 0 | 0 | 0 |
| 22Cr—2Al | 40 | 22 | 22 | 14 | 2 | — | — | — |
| 22Cr—3Al | 39 | 22 | 22 | 14 | 3 | — | — | — |
| 22Cr—4Al | 32 | 22 | 28 | 14 | 4 | — | — | — |
| 22Cr—5Al | 37 | 22 | 22 | 14 | 5 | — | — | — |
| 22Cr—4Al1Ta | 37 | 22 | 22 | 14 | 4 | 1 | — | — |
| 22Cr—4Al2Ta | 36 | 22 | 22 | 14 | 4 | 2 | — | — |
| 16Cr—2Al | 46 | 16 | 22 | 14 | 2 | — | — | — |
| 16Cr—3Al | 45 | 16 | 22 | 14 | 3 | — | — | — |
| 16Cr—4Al | 44 | 16 | 22 | 14 | 4 | — | — | — |
| 16Cr—5Al | 43 | 16 | 22 | 14 | 5 | — | — | — |
| 16Cr—4Al1Ta | 43 | 16 | 22 | 14 | 4 | 1 | — | — |
| 16Cr—4Al2Ta | 42 | 16 | 22 | 14 | 4 | 2 | — | — |
| 16Cr—34Ni—4Al | 32 | 16 | 34 | 14 | 4 | — | — | — |

Each alloy was prepared as 1 lb ingot by induction melting. Alloys were solution treated at 1200° C. for 6 hours, followed by air cooling. Two pieces cut from each alloy were aged for 100 hours at 900° C. and 1000° C., respectively. The aging treatments were completed by air cooling. Transmission electron microscopy and scanning electron microscopy were conducted to examine the presence of γ′-(Co,Ni)₃(Al,W) phase. Differential scanning calorimetry (DSC) was performed to determine liquidus, solidus and γ′ solvus temperatures.

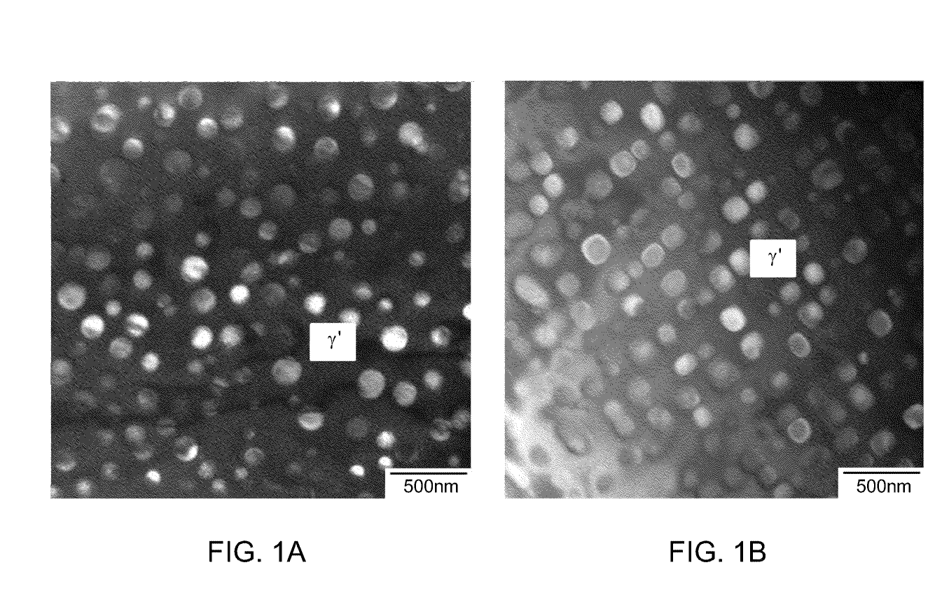

FIGS. 1A and 1B are transmission electron micrographs of Samples 16Cr-4Al2Ta and 16Cr-34Ni-4Al, respectively. As can be seen, these alloys, comprising 16 wt % chromium and 4 wt % Al, showed precipitation of γ′-(Co,Ni)₃(Al,W) phase in γ-(Co,Ni) matrix phase after heat treatments at 900° C. The size of γ′ precipitates is approximately 200 nm. Sample 16Cr-4Al1Ta also exhibited precipitation of γ′ phase, but the volume fraction of γ′ phase is less than half of that was observed in Sample 16Cr-4Al2Ta. None of the alloys containing 22 wt % Cr showed presence of γ′ phase after heat treatments at both 900 and 1000° C.

Transmission electron microscopy on the other alloys containing 16 wt % Cr revealed that super fine γ′ precipitates (<5 nm) are present in alloys with 3 wt % Al and 5 wt % Al after heat treatment at 900° C. The presence of super fine γ′ precipitates indicates that the γ′ solvus temperature in these alloys are lower than 900° C. and that the precipitation of γ′ phase occurred during air cooling from 900° C. The size of γ′ precipitates formed during cooling is significantly smaller than those formed during aging at 900° C. (as shown in FIG. 1), because there is not enough time for atoms to diffuse and to grow the precipitates during cooling.

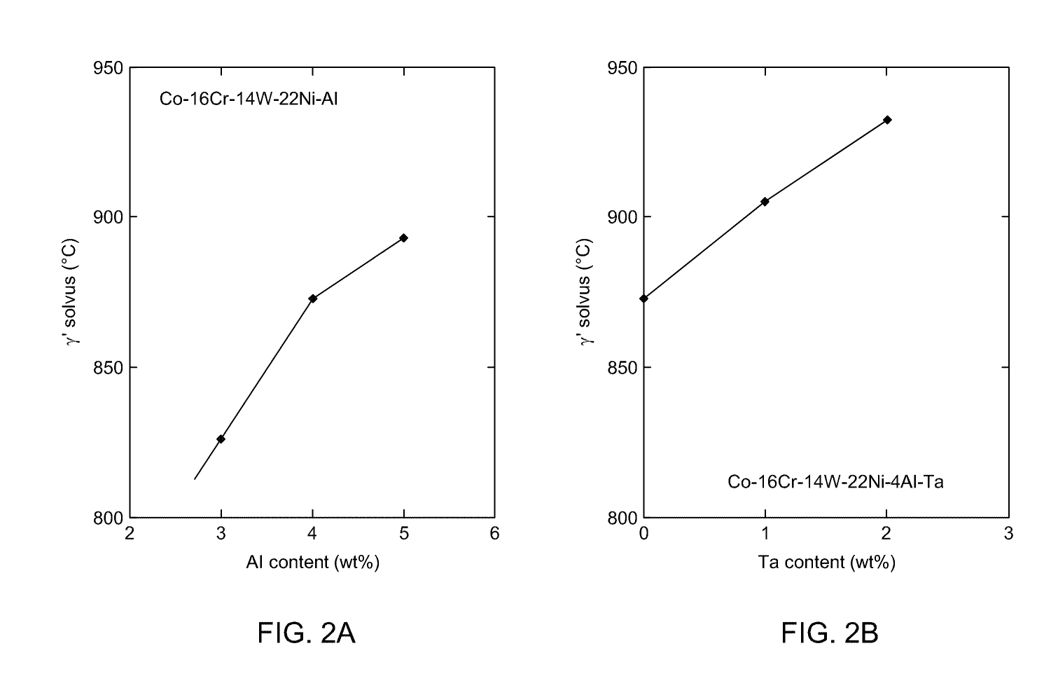

FIG. 2A shows dependency of γ′ solvus temperature on Al content in alloys containing 16 wt % Cr. The γ′ solvus temperature is 826° C. at 3 wt % Al, and is raised to 873° C. by increasing Al to 4 wt %. Further addition of Al to 5 wt % gives another increase in γ′ solvus to 893° C., but the increment is smaller than that was observed between 3 wt % Al and 4 wt % Al.

The alloy containing 5 wt % Al exhibits significant amount of B2-(Co,Ni)Al precipitates at 900° C. This indicates that there is a solubility limit of Al in γ+γ′ phase region between 4 wt % and 5 wt %, and that excess Al beyond the solubility limit causes a formation of undesirable B2 phase.

FIG. 2B shows dependency of γ′ solvus temperature on Ta content in alloys containing 16 wt % Cr-4 wt % Al. The γ′ solvus linearly increases from 873° C. with additions of Ta, and reaches 932° C. at 2 wt % Ta.

Taken together, this data indicates that there is an unexpected local composition window where γ′ phase is usable as a strengthening phase without forming other undesirable phases around 16 wt % Cr-4 wt % Al. At Al content lower than 4 wt %, the γ′ solvus temperature is lower (in other words, volume fraction of γ′ phase is lower), on the other hand, higher Al content beyond 4 wt % causes a formation of undesiable B2 phase. At 16 wt % Cr-4 wt % Al, the increased γ′ solvus temperatures observed with additions of Ta indicate that Ta is a very effective element to increase the stability of γ′ phase. In Co—Al—W—Ta alloys, γ′ solvus temperature drops from 1079° C. to 960° C. by addition of about 3 wt % Cr (Suzuki and Pollock: Acta Mater, vol. 56, 2008, pp. 1288-1297). Considering this strong effect of Cr in destabilizing γ′ phase, the presence of local composition window at 4 wt % Al in alloys containing 16 wt % Cr and the γ′ solvus higher than 900° C. (approximately 930° C.) achieved at 4 wt % Al-2 wt % Ta is quite remarkable.

In Sample 16Cr-34Ni-4Al, the γ′ solvus temperature is 930° C., which is equivalent to that of 16Cr-4Al2Ta alloy. This result suggests that both Ta and Ni are γ′ stabilizing elements. However, Ta is more effective than Ni in stabilizing γ′ phase, since γ′ solvus temperatures of alloys based on 16Cr-4Al (containing 22 wt % Ni) with an addition of 2 wt % Ta and an addition of 12 wt % Ni are equivalent.

The present invention has been described in terms of some specific embodiments. They are intended for illustration only, and should not be construed as being limiting in any way. Thus, it should be understood that modifications can be made thereto, which are within the scope of the invention and the appended claims. Furthermore, all of the patents, patent applications, articles, and texts which are mentioned above are incorporated herein by reference.

1. A cobalt-nickel alloy composition, comprising, by weight:
about 30% to about 50% cobalt;
about 20% to about 40% nickel;
at least about 10% chromium;
aluminum; and
at least one refractory metal;
wherein the alloy composition comprises L1₂-structured (gamma prime) phase precipitates having the formula (Co, Ni)₃(Al,Z), wherein Z is the at least one refractory metal, and a γ-(Co,Ni) matrix phase.

2. The alloy composition of claim 1, wherein the refractory metal is selected from the group consisting of tungsten, molybdenum, tantalum, niobium, rhenium, vanadium, and combinations thereof.

3. The alloy composition of claim 2, wherein at least about 50 weight % of the total refractory metal content comprises tungsten.

4. The alloy composition of claim 1, wherein the amount of cobalt present is in the range of about 32% by weight to about 48% by weight.

5. The alloy composition of claim 1, wherein the amount of cobalt present is in the range of about 38% by weight to about 46% by weight.

6. The alloy composition of claim 1, wherein the amount of nickel is in the range of about 20% to about 35%.

7. The alloy composition of claim 1, wherein the amount of nickel is in the range of about 20% to about 25%.

8. The alloy composition of claim 1, wherein the amount of chromium present is at least about 10%.

9. The alloy composition of claim 1, wherein the amount of chromium present is in the range of about 10% to about 18%.

10. The alloy composition of claim 1, wherein the amount of aluminum present is at least about 3%.

11. The alloy composition of clam 10, wherein the amount of aluminum present is in the range of about 3% to about 5%.

12. The alloy composition of claim 3, wherein the at least one refractory metal comprises tungsten, tantalum or a combination of these.

13. The alloy composition of claim 12, comprising from about 10% by weight to about 16% by weight tungsten.

14. The alloy composition of claim 12, comprising up to about 4% by weight tantalum.

15. An alloy composition comprising:
about 30 wt % to about 50 wt % cobalt;
about 20 wt % to about 40 wt % nickel;
about 10 wt % to about 18 wt % chromium;
about 2 wt % to about 5 wt % aluminum;
about 10 wt % to about 16 wt % tungsten; and
up to about 4 wt % tantalum.

16. The alloy composition of claim 15, comprising:
about 32 wt % to about 48 wt % cobalt;
about 20 wt % to about 35 wt % nickel;
about 12 wt % to about 18 wt % chromium;
about 3 wt % to about 5 wt % aluminum;
about 10 wt % to about 16 wt % tungsten; and
up to about 4 wt % tantalum.

17. The alloy composition of claim 16, comprising:
about 32 wt % to about 48 wt % cobalt;
about 20 wt % to about 35 wt % nickel;
about 14 wt % to about 18 wt % chromium;
about 3 wt % to about 5 wt % aluminum;
about 11 wt % to about 15 wt % tungsten; and
up to about 3 wt % tantalum.

18. The alloy composition of claim 17, comprising:
about 38 wt % to about 46 wt % cobalt;
about 20 wt % to about 25 wt % nickel;
about 14 wt % to about 18 wt % chromium;
about 3 wt % to about 5 wt % aluminum;
about 11 wt % to about 15 wt % tungsten; and
up to about 3 wt % tantalum.

19. A cast article, comprising the cobalt-nickel alloy composition of claim 1.

20. A gasification component, comprising an alloy which comprises:
about 30% to about 50% cobalt;
about 20% to about 40% nickel;
at least about 10% chromium;
aluminum; and
at least one refractory metal;
wherein the alloy composition comprises L1₂-structured (gamma prime) phase precipitates having the formula (Co, Ni)₃(Al,Z), wherein Z is the at least one refractory metal, and a γ-(Co,Ni) matrix phase.

21. An article, comprising
a) a substrate which comprises a metal or metal alloy; and
b) a cladding bonded to at least a portion of the substrate, wherein the cladding comprises a cobalt-nickel alloy, comprising, by weight:
about 30% to about 50% cobalt;
about 20% to about 40% nickel;
at least about 10% chromium;
aluminum; and
at least one refractory metal;
wherein the alloy composition comprises L1₂-structured (gamma prime) phase precipitates having the formula (Co, Ni)₃(Al,Z), wherein Z is the at least one refractory metal, and a γ-(Co—Ni) matrix phase.

22. The article of claim 21, wherein the substrate is a gasification component.
